(19) United States
(12) Patent Application Publication
(10) Pub. No.: US 2009/0128312 A1
(43) Pub. Date: May 21, 2009

(54) Switch having information display function for on-vehicle apparatus

(75) Inventors: Shinichi Sawada, Aichi-ken (JP); Yasuhiro Sakakibara, Aichi-ken (JP); Minoru Shibata, Aichi-ken (JP); Naoki Omatsu, Aichi-ken (JP); Atsunosuke Tanaka, Aichi-ken (JP); Naoki Tsukamoto, Aichi-ken (JP); Hirotaka Okada, Aichi-ken (JP)

Correspondence Address: POSZ LAW GROUP, PLC, 12040 SOUTH LAKES DRIVE, SUITE 101, RESTON, VA, 20191, US

(73) Assignee: TOYODA GOSEI CO., LTD., Aichi-ken (JP)

(21) Appl. No.: 12/289,549

(22) Filed: Oct. 30, 2008

(30) Foreign Application Priority Data
Nov. 16, 2007 (JP) 2007-298064

(51) Int. Cl. B60Q 1/00

(52) U.S. Cl. 340/438

(57) ABSTRACT

A compartment temperature adjustment switch 12 is provided for successively switching a target temperature of a compartment air conditioner through pushing operation of a push button 12a. The switch 12 includes the push button 12a, a substrate 22 fixed to the push button 12a, and light emitting elements 23 mounted on the substrate 22. The segments are selectively illuminated when the light emitting elements 23 are turned on, and a target temperature is numerically displayed on the push button 12a by a combination of illuminated ones of the segments. An information display portion is integrally formed with the push button 12a.

### BACKGROUND OF THE INVENTION

The present invention relates to a switch having information display function for an on-vehicle apparatus, such as a car air conditioner, which switch is operated to operate the on-vehicle apparatus.

A control panel is provided in the passenger compartment of a vehicle so that on-vehicle apparatuses such as a car air conditioner, a car audio system, and a navigation device are operated through the control panel. Specifically, through operation of switches provided on the control panel, the operation settings of the on-vehicle apparatuses are changed. As one such type of switches provided on the control panel, a push-button switch is known. Each time the switch is operated, the operation setting of the corresponding on-vehicle apparatus is switched successively from one setting to another. For example, a control panel of a car air conditioner described in Japanese Laid-Open Patent Publication No. H10-297256 includes a plurality of push-button switches. These switches include a switch to selectively raise and lower the target temperature of the air conditioner in a successive manner, a switch to selectively increase and decrease the flow rate of air discharged from the air conditioner in a successive manner, and a switch to switch the vent mode of the air conditioner successively. Unlike dial switches, the push-button switches do not allow the operator to check the operation setting of an on-vehicle apparatus directly from the position of the switch when setting the operation setting of the apparatus. The control panel thus must have an independent information display portion (an indicator) that displays information regarding the current operation setting of each one of the on-vehicle apparatuses.

FIG. 12 illustrates an example of a conventional control panel through which a car air conditioner is operated. With reference to the drawing, as the above-described push-button switches, the control panel includes a switch 101 to selectively raise and lower the target temperature in the passenger compartment, a switch 102 to selectively increase and decrease the air flow amount, and a switch 103 to selectively switch the air blow mode. An indicator 104, which is formed by a liquid crystal panel to display the current target temperature, the current air flow amount, and the current vent mode, is arranged at a position spaced from the switches 101 to 103.

Since the indicator 104 is spaced from the switches 101 to 103, the operability and visibility of the indicator 104 are low. Specifically, when the operator operates any one of the switches 101 to 103, the operator must look away from the switch 101 to 103 to look at the indicator 104 to check the operation setting of the corresponding apparatus, each time it is necessary for the operator. Further, the indicator 104 adds to the surface area of the control panel. Accordingly, such structure may be improved in terms of saving space in the control panel.

Japanese Laid-Open Patent Publications Nos. 2006-134715 and 2006-164573, for example, each disclose a switch that displays operation setting of an on-vehicle apparatus simply in an ON-OFF manner. The switch includes a light emitting portion, which is selectively turned on and off in correspondence with an ON state and an OFF state of the switch to display the operation setting of the on-vehicle apparatus. However, the switch is capable of displaying an only limited amount of information. In other words, the switch cannot switch the operation setting of the on-vehicle apparatus in more than two steps. Also, the operation setting displayed by the switch is not easy to check.

### SUMMARY OF THE INVENTION

Accordingly, it is an objective of the present invention to provide a switch having information display function for an on-vehicle apparatus, which switch is easily operated with improved visibility and saves space.

To achieve the foregoing objective and in accordance with one aspect of the present invention, a switch having an information display function for an on-vehicle apparatus is provided. The switch includes a push button and an information display portion. An operation setting of the on-vehicle apparatus is successively changed in more than two steps by pushing operation of the push button. The information display portion has a plurality of light emitting elements. The information display portion is arranged integrally with the push button. A specific symbol is displayed on the push button in accordance with each step of the operation setting of the on-vehicle apparatus. The symbol is expressed by a combination of segments that are selectively illuminated when the light emitting elements are turned on.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a front view showing a control panel having a switch with information display function according to a first embodiment of the present invention;

FIG. 2(a) is a front view showing an example of display by a vent mode switch;

FIG. 2(b) is a front view showing an example of display by a compartment temperature adjustment switch;

FIG. 2(c) is a front view showing an example of display by an air flow amount adjustment switch;

FIG. 2(d) is a front view showing an example of display by a seat temperature adjustment switch;

FIG. 3 is a cross-sectional view taken along line 3-3 of FIG. 2(b), showing the compartment temperature adjustment switch;

FIG. 4 is a cross-sectional view taken along line 4-4 of FIG. 2(b), showing the compartment temperature adjustment switch;

FIG. 5 is a cross-sectional view schematically showing a push button of the switch with information display function;

FIGS. 6(a) to 6(d) are cross-sectional views illustrating the push button of FIG. 5 in respective manufacturing steps of the push button;

FIG. 7 is a cross-sectional view schematically showing a push button of a switch with information display function for an on-vehicle apparatus according to a second embodiment of the present invention;

FIGS. 8(a) to 8(d) are cross-sectional views each illustrating the push button of FIG. 7 in respective manufacturing steps of the push button;

FIG. 9 is a cross-sectional view schematically showing a push button of a switch with information display function for an on-vehicle apparatus, according to a third embodiment of the present invention;

FIGS. 10(a) to 10(d) are cross-sectional views each illustrating the push button of FIG. 9 in respective manufacturing steps of the push button;

FIG. 11 is a cross-sectional view schematically showing a switch with information display function for an on-vehicle apparatus according to a fourth embodiment of the present invention; and

FIG. 12 is a front view showing, by way of example, a conventional control panel through which a car air conditioner is operated.

### DETAILED DESCRIPTION OF THE PREFERRED EMBODIMENTS

### First Embodiment

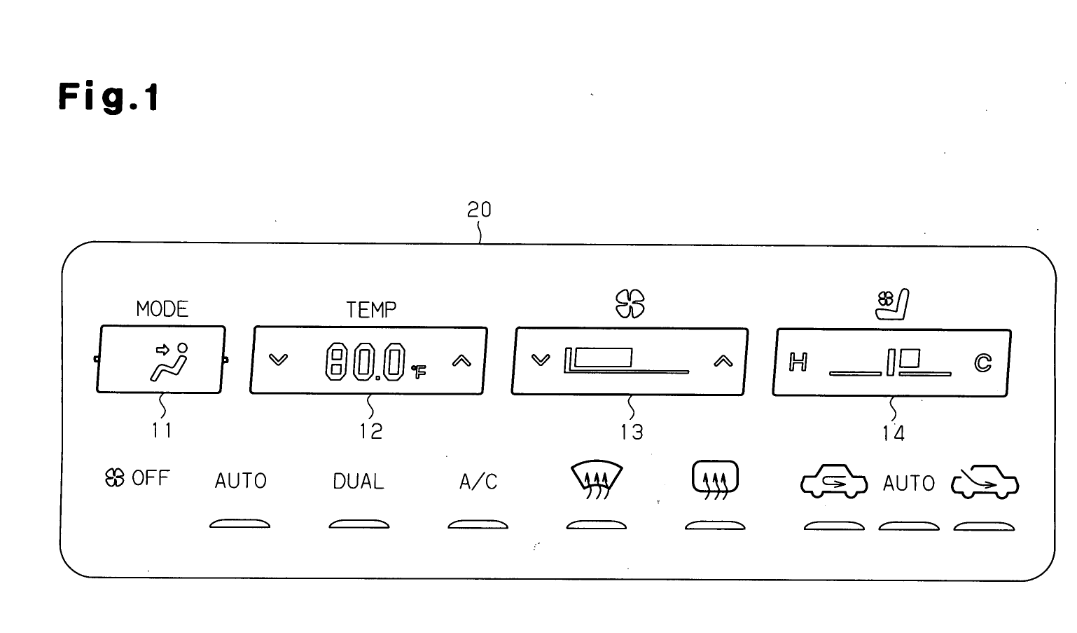

A switch having information display function for an on-vehicle apparatus according to a first embodiment of the present invention will be described in detail with reference to FIGS. 1 to 6.

FIG. 1 is a front view showing a control panel 20 including switches 11, 12, 13, 14, each with information display function, according to the first embodiment. In other words, the four switches 11 to 14 on the control panel 20 are operated to operate either a car air conditioner or a seat temperature adjustment apparatus (neither is shown), each serving as an on-vehicle apparatus.

The switches 11 to 14 of the control panel 20 are switches with information display function and each display information regarding the operation setting of either the car air conditioner or the seat temperature adjustment apparatus on a surface of a push button of the switch 11 to 14. These operation settings are each switched in more than two steps by pressing the corresponding push buttons of the switches 11 to 14. The switches 11 to 14 are, specifically, a vent mode switch 11, a compartment temperature adjustment switch 12, an air flow amount adjustment switch 13, and a seat temperature adjustment switch 14.

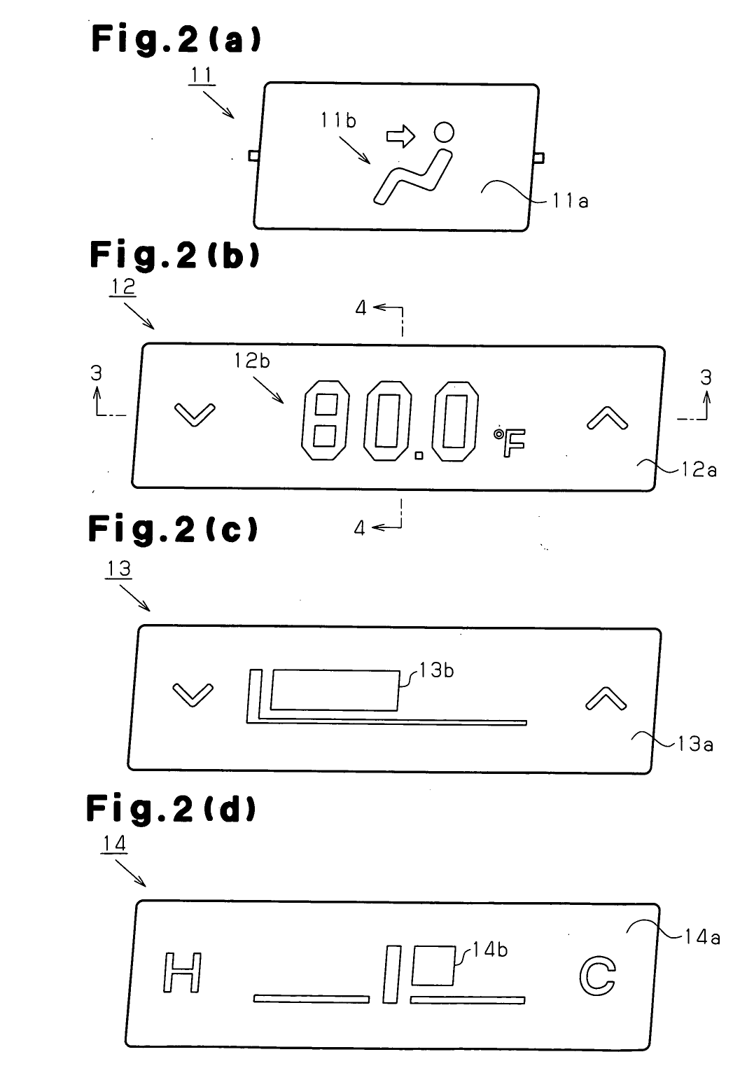

The vent mode switch 11, which is illustrated in FIG. 2(a), is operated to switch the vent mode of the car air conditioner, or the outlet through which the air is to be blown. The vent mode switch 11 includes a push button 11a. Each time the push button 11a is pressed, the vent mode is switched successively.

A plurality of outlets are provided in the passenger compartment in order to blow the air. Each time the vent mode is switched, the outlets are switched. Specifically, the outlets in the passenger compartment include a register, a floor outlet, and a defroster. The air passing through the register is sent toward the head of an occupant. The air flowing through the floor outlet is sent toward the foot of the passenger. The air from the defroster is blown against the windshield of the vehicle. The push button 11a is pressed to select any one of the outlets to blow air.

In the first embodiment, the vent mode is switched among a “FACE” mode in which the air is blown solely through the register, a “B/L” mode in which the air is blown through the register and the floor outlet, a “FOOT” mode in which the air blow occurs only from the floor outlet, an “F/D” mode in which the air blow is carried out through the floor outlet and the defroster, and a “DEF” mode in which the air is blown only through the defroster. Only one of the vent modes is selected at one time. Each time the push button 11a of the vent mode switch 11 is pressed, the vent mode is switched in a circulating manner in the order of “FACE”, “B/L”, “FOOT”, “F/D”, “DEF”, and “FACE”. The surface of the push button 11a displays an illuminated icon specific to the currently selected one of the vent modes. For example, in FIG. 2(a), an image (an icon 11b) indicating that the “FACE” mode is currently selected as the vent mode is illuminated and displayed on the surface of the push button 11a.

The compartment temperature adjustment switch 12, which is illustrated in FIG. 2(b), is operated to change the target temperature of the car air conditioner (a target passenger compartment temperature). Specifically, each time the right end of the push button 12a of the switch 12 is pressed, the passenger compartment temperature is raised by 0.5° F. (0.3° C.). Each time the left end of the push button 12a is pressed, the target temperature is lowered by 0.5° F. In FIG. 2(b), by way of example, a numerical indicator 12b indicating that the target temperature is set currently at 80.0° F. (26.7° C.) is illuminated and displayed on the surface of the push button 12a.

The air flow amount adjustment switch 13, which is shown in FIG. 2(c), is operated to adjust the air flow amount (the air flow intensity) from the selected outlet(s) of the car air conditioner. Specifically, each time the right end of the push button 13a of the switch 13 is pressed, the air flow intensity is intensified by one step. Each time the left end of the push button 13a is pressed, the air flow intensity is weakened by one step. The thus adjusted air flow intensity is indicated by the length of a bar 13b, which is illuminated and displayed on the surface of the push button 13a. The length of the bar 13b becomes greater as the air flow amount becomes greater.

The seat temperature adjustment switch 14, which is illustrated in FIG. 2(d), is operated to change the target temperature of the seat temperature adjustment apparatus. Each time the right end of the push button 14a of the switch 14 is pressed, the target temperature of the seat temperature adjustment apparatus is lowered by one step. Each time the left end of the push button 14a is pressed, the target temperature of the seat temperature adjustment apparatus is raised by one step. The thus adjusted target temperature of the seat temperature adjustment apparatus is indicated by a bar 14b that is illuminated and displayed on the surface of the push button 14a, specifically depending on the length of the bar 14b and the direction in which the bar 14b extends. More specifically, as the bar 14b extends further from the middle to the right end, the target temperature becomes lower. As the bar 14b extends further from the middle to the left end, the target temperature becomes higher.

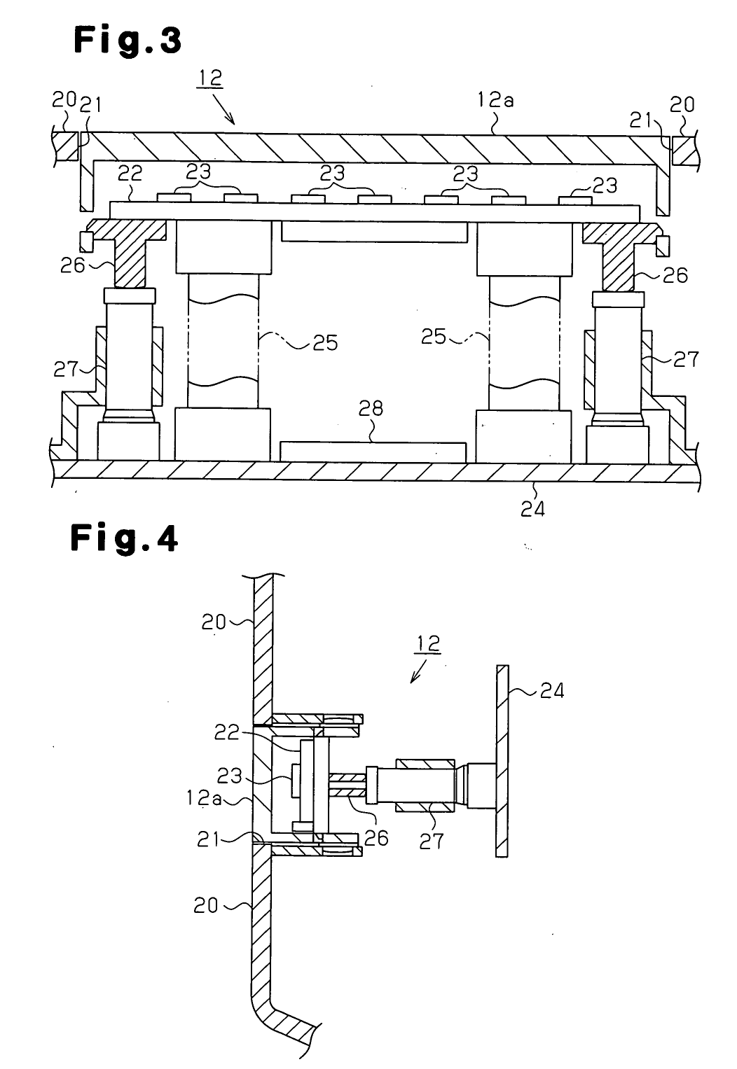

The configurations of the switches 11 to 14 with information display function will hereafter be explained in detail, with the compartment temperature adjustment switch 12 cited as an example. FIG. 3 shows a cross section of the compartment temperature adjustment switch 12 taken along line 3-3 of FIG. 2(b). FIG. 4 shows a cross section of the switch 12 taken along line 4-4 of FIG. 2(b).

With reference to FIGS. 3 and 4, the push button 12a of the compartment temperature adjustment switch 12 is arranged in a button opening 21 formed in the control panel 20. In this state, the push button 12a is movable along the front and rear direction (in the up and down direction as viewed in FIG. 3). When the right end or the left end of the push button 12a is pressed, the push button 12a sinks and inclines at the pressed side. When the push button 12a is released, the push button 12a restores its original position.

A substrate 22 is fixed at the backside (the lower side as viewed in FIG. 3) of the push button 12a. A plurality of light emitting elements 23 are mounted on the top surface (the upper surface as viewed in FIG. 3) of the substrate 22. In the first embodiments, the light emitting elements 23 are light emitting diodes (LEDs). The light emitting elements 23 configure segments that display the numerical indicator 12b on the surface of the push button 12a. By selectively turning on the light emitting elements 23, corresponding ones of the segments are illuminated. In this manner, the segments are illuminated in different combinations in such a manner as to define the numerical indicator 12b in accordance with patterns formed by the illuminated segments. The numerical indicator 12b is thus displayed on the surface of the push button 12a as the target temperature.

A main substrate 24 is arranged at the backside of the push button 12a, while being fixed to the front side of the vehicle. The substrate 22 fixed to the push button 12a and the main substrate 24 are electrically connected to each other through a flexible cable 25. Two projections 26 are fixed to opposite ends of the backside of the substrate 22. The distal end of each one of the projections 26 contacts a corresponding one of two tactile switches 27 located on the main substrate 24. Each one of the tactile switches 27 detects that the corresponding one of the ends of the push button 12a has been pressed.

A control circuit 28 is located on the main substrate 24 to control the light emitting elements 23 to emit light in response to detection by the tactile switches 27 that the push button 12a has been pressed. The control circuit 28 selects those of the light emitting elements 23 that are illuminated to turn on the segments necessary for forming the numerical indicator displayed as the current target temperature of the car air conditioner. The control circuit 28 also sends a command signal instructing to illuminate the selected ones of the light emitting elements 23 to the substrate 22 through the flexible cable 25. In response to the command signal, a circuit (not shown) formed on the substrate 22 supplies a voltage necessary for emitting light to those of the light emitting elements 23 that are instructed to illuminate by the command signal.

The other switches 11, 13, 14 with information display function are different from the compartment temperature adjustment switch 12 only in that the switches 11, 13, 14 display specific symbols (the icon 11b and the bars 13b, 14b) different from the numerical indicator 12b of the compartment temperature adjustment switch 12. The switches 11, 13, 14 with information display function are configured substantially identical with the compartment temperature adjustment switch 12. However, the vent mode switch 11 is different from the compartment temperature adjustment switch 12 in that the switch 11 includes only a single projection 26 and a single tactile switch 27.

The configuration of each one of the push buttons 11a to 14a will hereafter be explained.

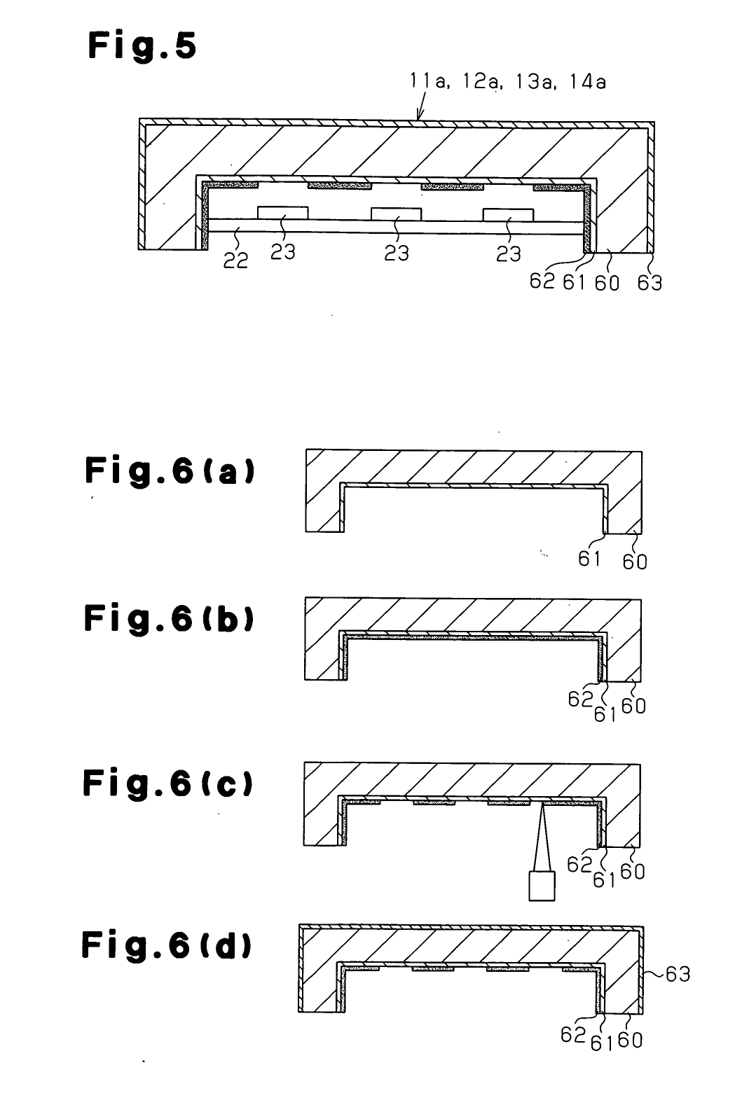

FIG. 5 shows a cross section of each push button 11a to 14a in detail.

Specifically, the substrate 22 on which the light emitting elements 23 are mounted is fixed to the push button 11a to 14a. The base of the push button 11a to 14a is a base material 60 formed of translucent resin (in the first embodiment, transparent tinted resin). A semitransparent vapor-deposited layer 61 and a light shielding first paint layer 62 are formed sequentially on the backside of the base material 60. A semitransparent second paint layer 63 is formed on the top side of the base material 60.

The vapor-deposited layer 61 is provided on the backside of each push button 11a to 14a through multi vapor deposition of three to seven layers. Such deposition is accomplished by alternately depositing a layer formed of material with a high refractive index such as titanium dioxide (TiO₂) and a layer formed of material with a low refractive index such as silicon dioxide (SiO₂). The vapor-deposited layer 61 forms a half mirror that permits transmission of light from the interior of the corresponding switch 11 to 14 to the exterior and reflects the light entered from the exterior of the switch 11 to 14 to the interior.

The first paint layer 62 is provided by applying light shielding paint, of which the color is, for example, black, on the vapor-deposited layer 61. However, the portions of the first paint layer 62 corresponding to the segments to be illuminated are removed from the first paint layer 62. The light emitted by any one of the light emitting elements 23 is thus radiated to the exterior through the corresponding one of the portions from which the first paint layer 62 is removed. This illuminates the corresponding one of the segments.

The second paint layer 63 is provided by applying semitransparent paint, which has, for example, a tinted color, on the surface of the base material 60. In the first embodiment, the color and the thickness of the paint are set in such a manner that the light transmission rate of the second paint layer 63 is 45%.

A method for manufacturing each push button 11a to 14a will now hereafter be explained with reference to FIGS. 6(a) to 6(d).

To manufacture the push buttons 11a to 14a, the base material 60 is molded using a transparent tinted resin material. Then, the multi vapor deposition is carried out by alternately depositing a layer with a high refractive index formed of, for example, titanium dioxide (TiO₂) and a layer with a low refractive index formed of, for example, silicon dioxide (SiO₂) so that three to seven such layers are formed. In this manner, as illustrated in FIG. 6(a), the vapor-deposited layer 61 is completed.

Subsequently, light shielding paint is applied to the vapor-deposited layer 61 so that the first paint layer 62 is provided with reference to FIG. 6(b). Next, as illustrated in FIG. 6(c), the portions the first paint layer 62 that correspond to the segments are removed through laser trimming.

Finally, as illustrated in FIG. 6(d), tinting paint is applied to the top surface of the base material 60 to form the second paint layer 63. The push button 11a to 14a is thus completed.

In the thus manufactured push button 11a to 14a, the light shielding first paint layer 62 is formed on the backside of the push button 11a to 14a. The portions from which the first paint layer 62 is removed, or the segments, and the light emitting elements 23 are located close to each other. This structure radiates the light emitted by each light emitting element 23 through the corresponding illuminated segment while substantially preventing the light from leaking from the segments other than the segments. As a result, the non-illuminated ones of the segments are prevented from being illuminated slightly due to the light leaked from the illuminated segment.

To ensure sufficient visibility of the illuminated display and sufficient light shielding performance of segments in non-illuminated states, the light transmission rate of each segment of the push button 11a to 14a, which is manufactured as described above, is set preferably to 20% to 50%, and, more preferably, to 25% to 40%.

In the first embodiment, the light emitting elements 23, the substrate 22 on which the light emitting elements 23 are mounted, and the push buttons 11a to 14a form an information display portion. Further, in the first embodiment, the vent mode (the identification number of the vent mode) of the vent mode switch 11, the target temperature of the car air conditioner of the compartment temperature adjustment switch 12, the air blowing intensity of the air flow amount adjustment switch 13, and the target temperature of the seat temperature adjustment apparatus of the seat temperature adjustment switch 14 each correspond to an operation setting of the on-vehicle apparatus that is switched from one setting to another through operation of the corresponding push button 11a to 14a.

The switch with information display function according to the first embodiment has the following advantages.

(1) The operation setting of each on-vehicle apparatus is switched successively in more than two steps by pressing the push button 11a to 14a of the corresponding switch 11 to 14. The switches 11 to 14 include an information display portion that illuminates and displays a specific symbol on the surface of the push button 11a to 14a. The symbol is displayed depending on which of the segments are illuminated in combination by the light emitted by the corresponding ones of the light emitting elements 23. The symbol is switched in accordance with the steps corresponding to the respective operation settings through operation of the corresponding switch 11 to 14.

For example, the vent mode switch 11 illuminates and displays the icon 11b, which indicates the currently set vent mode, on the surface of the push button 11a. The compartment temperature adjustment switch 12 illuminates and numerically displays the current target temperature on the surface of the push button 12a. The air flow amount adjustment switch 13 illuminates and displays the currently set air flow intensity on the surface of the push button 13a in correspondence with the length of the bar 13b. The seat temperature adjustment switch 14 illuminates and displays the seat target temperature on the surface of the push button 14a in correspondence with the length and the extending direction of the bar 14b.

The substrate 22, on which the information display portion performing such illumination and display, or the light emitting elements 23, are mounted, and the first paint layer 62, from which the portions corresponding to the segments to be illuminated are removed, are provided as an integral body with each of the push buttons 11a to 14a. In other words, information regarding the operation setting of the on-vehicle apparatus switched through pressing of each push button 11a to 14a is displayed directly by the push button 11a to 14a of the switch 11 to 14. This enables the operator to check the operation setting of the on-vehicle apparatus that the operator changes by operating each switch 11 to 14, without looking away from the switch 11 to 14. Further, since the information display portion of each switch 11 to 14 does not have to be spaced from the switch 11 to 14, the space for accommodating the switches 11 to 14 is reduced. As a result, the switches 11 to 14 with information display function according to the first embodiment are easily operated with improved visibility and save space.

(2) The target temperature of the car air conditioner is changed successively by pressing the push button 12a of the compartment temperature adjustment switch 12. The target temperature is illuminated and displayed numerically on the surface of the push button 12a. This structure allows the operator to easily check the target temperature that the operator is adjusting, without looking away from the push button 12a that is being operated. The switch 12 is thus easily operated with increased visibility.

(3) The air flow intensity of the car air conditioner is changed successively by pressing the push button 13a of the air flow amount adjustment switch 13. The air flow intensity is indicated by the length of the bar 13b that is illuminated and displayed on the surface of the push button 13a. The target temperature of the seat temperature adjustment apparatus is changed by pressing the push button 14a of the seat temperature adjustment switch 14. The target temperature is indicated by the length and the extending direction of the bar 14b that is illuminated and displayed on the surface of the push button 14a. This allows the operator to easily check the air flow intensity and the target temperature that the operator is adjusting, without looking away from the corresponding push buttons 13a, 14a. The switches 13, 14 are thus easily operated with improved visibility.

(4) The substrate 22, on which the light emitting elements 23 are mounted, is fixed to the backside of each push button 11a to 14a formed of the translucent resin material. This simplifies the configuration of each switch 11 to 14 that displays information regarding the operation setting of the corresponding on-vehicle apparatus, which is switched successively by pressing the switch 11 to 14.

(5) The first paint layer 62 formed of the light shielding paint is formed on the backside of each push button 11a to 14a and the portions corresponding to the segments to be illuminated are removed from the first paint layer 62. The substrate 22 is fixed to the backside of the push button 11a to 14a. The light emitted by the light emitting elements 23, which are mounted on the substrate 22, passes through the corresponding portions from which the first paint layer 62 is removed and is thus radiated to the exterior of the corresponding push button 11a to 14a. In this manner, the symbol representing the operation setting of the corresponding on-vehicle apparatus is illuminated and displayed on the surface of the push button 11a to 14a. As a result, by changing the shape formed by the removed portions of the first paint layer 62, a symbol having a desired shape is easily displayed through illumination.

(6) The light emitting elements 23 mounted on the substrate 22, which is located behind the back surface of each push button 11a to 14a, and the segments illuminated by the light emitted by the light emitting elements 23, or the portions from which the first paint layer 62 is removed, are held in tight contact. As a result, the light emitted by any one of the light emitting elements 23 is radiated solely through the corresponding one of the segments, without leaking into the other ones of the segments.

(7) The semitransparent vapor-deposited layer 61 and the light shielding first paint layer 62 are formed sequentially on the backside of each push button 11a to 14a. Also, the semitransparent second paint layer 63 is formed on the top surface of the push button 11a to 14a. The vapor-deposited layer 61 forms a half mirror that permits the light to permeate through the corresponding switch 11 to 14 from the interior to the exterior and reflects the light entering from the exterior of the switch 11 to 14. This structure causes those of the segments in non-illuminated states to become inconspicuous from the exterior of the switch 11 to 14. Since the vapor-deposited layer 61 is formed through the above-described multi vapor deposition, each push button 11a to 14a has a metallic appearance that is different from an appearance created by metal vapor deposition. Specifically, if the half mirror is formed through the metal vapor deposition, the appearance of the vapor-deposited layer becomes excessively metallic and the vapor-deposited layer has a glaring mirror-like surface. Contrastingly, if the multi vapor deposition is employed, the vapor-deposited layer 61 has a metallic appearance with a suppressed glare. Further, since the top surface of each push button 11a to 14a is not subjected to the metal vapor deposition, the push button 11a to 14a is maintained fingerprint-free and clean, regardless of operation of the push button 11a to 14a.

### Second Embodiment

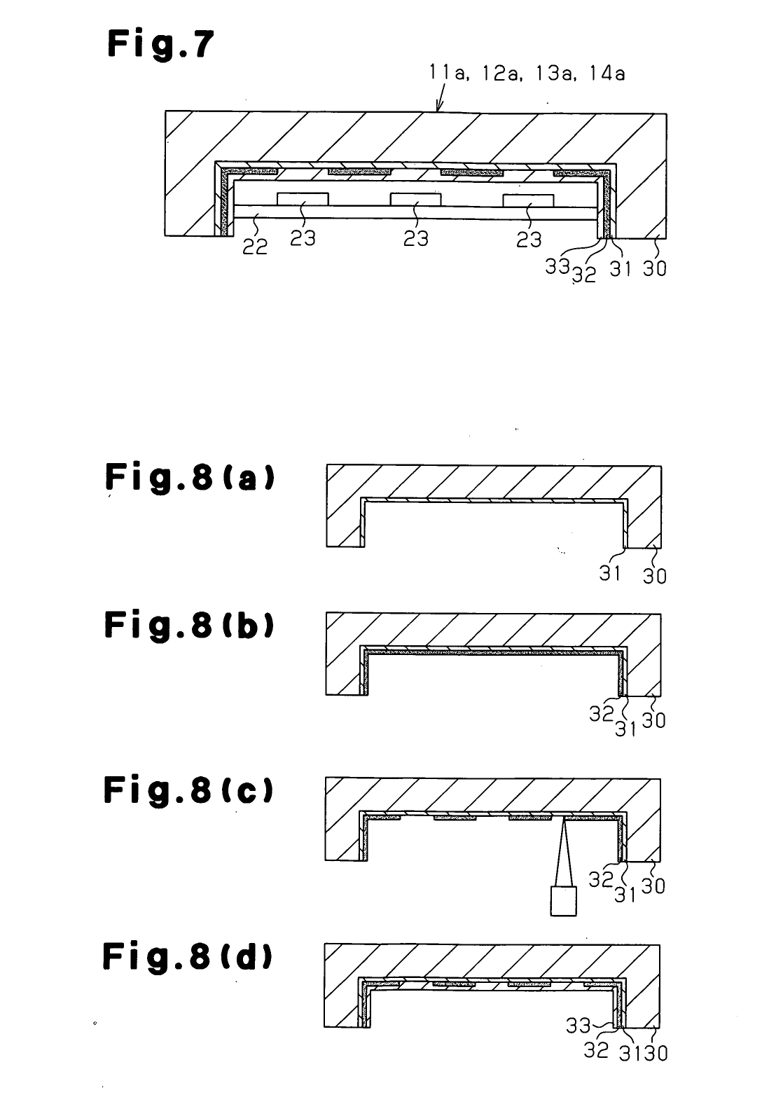

A switch with information display function for an on-vehicle apparatus according to a second embodiment of the present invention will hereafter be explained in detail with reference to FIGS. 7 and 8. In the second and the following embodiments, same or like reference numerals are given to components of these embodiments that are the same as or like corresponding components of the first embodiment and detailed description thereof is omitted. The switch with information display function for an on-vehicle apparatus according to the second embodiment is different from that of the first embodiment in terms of surface treatment of each push button 11a to 14a.

FIG. 7 shows a cross section of each push button 11a to 14a to which the corresponding substrate 22, on which the light emitting elements 23 are mounted, is fixed. The push button 11a to 14a is formed by a base material 30 formed of translucent resin (in the second embodiment, transparent tinted resin) and a first vapor-deposited layer 31, a paint layer 32, and a second vapor-deposited layer 33, which are formed sequentially on the backside of the base material 30.

The first vapor-deposited layer 31 is formed on the backside of the push button 11a to 14a through multi vapor deposition of three to seven layers. The multi vapor deposition is carried out by depositing a layer formed of material with a high refractive index such as titanium dioxide (TiO₂) and a layer formed of material with a low refractive index such as silicon dioxide (SiO₂) alternately.

The paint layer 32 is provided by applying light shielding paint, of which the color is, for example, black, on the first vapor-deposited layer 31. However, the portions of the paint layer 32 corresponding to the segments to be illuminated are removed from the paint layer 32. The light emitted by any one of the light emitting elements 23 is thus radiated to the exterior through the corresponding one of the portions from which the paint layer 32 is removed. The light thus illuminates the corresponding one of the segments.

The second vapor-deposited layer 33 is provided by depositing metal such as aluminum alloy on the paint layer 32 and portions from which the paint layer 32 is removed. The type of the metal to be deposited and the thickness of deposition are set in such a manner that the light transmission rate of the second vapor-deposited layer 33 becomes 35%. The second vapor-deposited layer 33 and the first vapor-deposited layer 31 form a half mirror that permits light transmission from the interior of the corresponding switch 11 to 14 to the exterior and reflects the light entering from the exterior of the switch 11 to 14.

Each push button 11a to 14a of the second embodiment is manufactured in accordance with the procedure illustrated in FIGS. 8(a) to 8(d). Specifically, to manufacture the push button 11a to 14a, the base material 30 is molded using a transparent tinted resin material. Then, multi vapor deposition is carried out by alternately depositing a layer with a high refractive index formed of, for example, titanium dioxide (TiO₂) and a layer with a low refractive index formed of, for example, silicon dioxide (SiO₂) so that three to seven such layers are stacked together. In this manner, as illustrated in FIG. 8(a), the first vapor-deposited layer 31 is provided.

Subsequently, light shielding paint is applied to the first vapor-deposited layer 31 so that the paint layer 32 is provided with reference to FIG. 8(b). Next, as illustrated in FIG. 8(c), the portions of the paint layer 32 corresponding to the segments are removed through laser trimming.

Finally, as illustrated in FIG. 8(d), metal such as aluminum alloy is deposited on the paint layer 32 and portions from which the paint layer 32 is removed. In this manner, the push buttons 11a to 14a are completed.

To ensure sufficient visibility of the illumination display and sufficient light shielding performance of the segments in the non-illuminated states, the light transmission rate of each segment of the push button 11a to 14a, which is manufactured as described above, is set preferably to 20% to 50%, and, more preferably, to 25% to 40%.

The switch with information display function for the on-vehicle apparatus according to the second embodiment, which has been described above, has the advantages equivalent to the advantages (1) to (7) of the first embodiment. Also, the second embodiment has the following advantage in addition to these advantages.

The first vapor-deposited layer 31, the paint layer 32, and the second vapor-deposited layer 33 are formed sequentially on the backside of each push button 11a to 14a. The first vapor-deposited layer 31 and the second vapor-deposited layer 33 form a half mirror that permits light transmission from the interior of the corresponding switch 11 to 14 to the exterior and reflects the light reaching from the exterior of the switch 11 to 14. This structure makes those of the segments in non-illuminated states inconspicuous from the exterior of the switch 11 to 14. Also, the second vapor-deposited layer 33 formed of deposited metal is visible from the exterior only through the segments, which correspond to portions from which the paint layer 32 is removed. Further, the second vapor-deposited layer 33 is visible only through the first vapor-deposited layer 31. This suppresses glare of the surface of each push button 11a to 14a caused by glaring of the metal of the second vapor-deposited layer 33. Further, since the top surface of the push button 11a to 14a is not subjected to metal vapor deposition, the push button 11a to 14a is maintained fingerprint-free and clean regardless of operation of the push button 11a to 14a.

### Third Embodiment

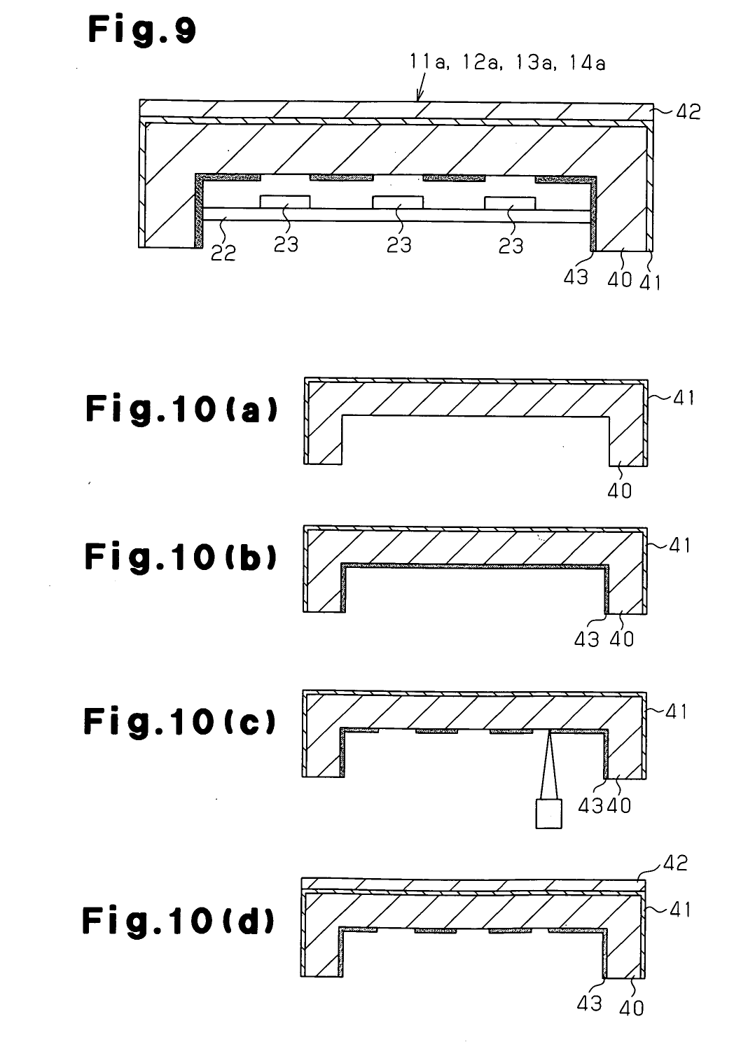

A switch with information display function for an on-vehicle apparatus according to a third embodiment of the present invention, will hereafter be explained with reference to FIGS. 9 and 10. The switch with information display function for an on-vehicle apparatus according to the third embodiment is different from the first and second embodiments in terms of surface treatment of each push button 11a to 14a. Specifically, the top surface of the push button 11a to 14a of this embodiment is subjected to metal vapor deposition so that a half mirror is formed. Those of the segments that are in non-illuminated states thus become invisible from the exterior of the corresponding switch 11 to 14.

FIG. 9 shows a cross section of a push button of the switch with information display function according to the third embodiment. With reference to the drawing, using metal such as an aluminum alloy, a vapor-deposited metal layer 41 is formed on the top surface of a base material 40, which is formed of transparent tinted resin material, or the base of each push button. The type of the metal used for the vapor-deposited metal layer 41 and the thickness of deposition are selected in such a manner that the light transmission rate of the vapor-deposited metal layer 41 becomes approximately 40%. A hard coating layer 42 formed of transparent paint is provided on the vapor-deposited metal layer 41 to protect the vapor-deposited metal layer 41. A paint layer 43 formed of light shielding paint is formed on the backside of the base material 40, which is transparent and tinted. The portions of the paint layer 43 corresponding to the segments to be illuminated are removed from the paint layer 43.

Each of the push buttons 11a to 14a, which is constructed as described above, is manufactured by the procedure illustrated in FIGS. 10(a) to 10(d). Specifically, to manufacture the push button 11a to 14a, the base material 40 is molded from light transmitting resin (in the third embodiment, transparent tinted resin). Then, aluminum vapor deposition is carried out on the top surface of the base material 40 so that the vapor-deposited metal layer 41 is formed as illustrated in FIG. 10(a). Subsequently, by applying light insulating paint onto the backside of the base material 40, the paint layer 43 is formed as illustrated in FIG. 10(b). Next, with reference to FIG. 10(c), the portions of the paint layer 43 corresponding to the segments are removed through laser machining. Finally, as illustrated in FIG. 10(d), the hard coating layer 42 is formed on the vapor-deposited metal layer 41 by applying transparent paint on the vapor-deposited metal layer 41. In this manner, the push button 11a to 14a is manufactured.

In each push button 11a to 14a, which is manufactured as described above, most of the light radiated from the exterior onto the corresponding switch 11 to 14 is reflected by the vapor-deposited metal layer 41 formed on the push button 11a to 14a. Those of the segments in non-illuminated states are thus invisible from the exterior of the switch 11 to 14. Accordingly, when all of the light emitting elements 23 are turned off, the surface of each push buttons 11a to 14a is visible as a surface with uniform brightness. Further, in each one of these push buttons 11a to 14a, the paint layer 43 is formed on the backside of the base material 40. The segments to be illuminated, or the portions from which the paint layer 43 is removed, and the light emitting elements 23 are located close to each other. The light emitted by any one of the light emitting elements 23 is radiated through the corresponding one of the segments to be illuminated, substantially without leaking from the other segments. That is, the light of the light emitting element 23 corresponding to the illuminated segment is substantially prevented from leaking to the other segments in the non-illuminated states. As a result, the portion except for the illuminated segment is visible as a surface with uniform brightness. In other words, those of the segments in non-illuminated states are invisible from the exterior of the corresponding switch 11 to 14.

Also in the push buttons 11a to 14a according to the third embodiment, in order to ensure sufficient visibility of the illumination display and sufficient light shielding performance of segments in non-illuminated states, the light transmission rate of each segment of the push button 11a to 14a is set preferably to 20% to 50%, and, more preferably, to 25% to 40%.

The switch with information display function for the on-vehicle apparatus according to the third embodiment, which has been described above, has the advantages equivalent to the advantages of the first embodiment. Also, the third embodiment has the following advantage.

The vapor-deposited metal layer 41 is formed on the top surface of each push button 11a to 14a. Since the vapor-deposited metal layer 41 functions as a half mirror, those of the segments that are in non-illuminated states are invisible from the exterior of the corresponding switch 11 to 14. This improves the appearance of the switch 11 to 14.

### Fourth Embodiment

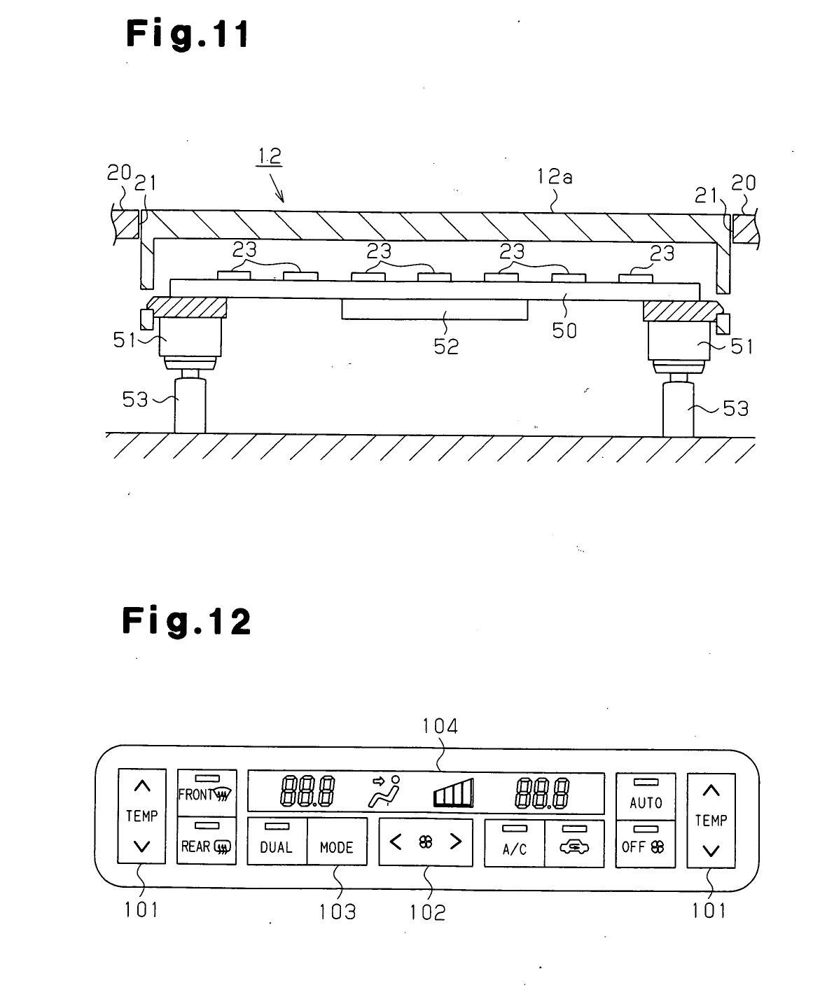

A switch with information display function for an on-vehicle apparatus according to a fourth embodiment of the present invention will be explained in detail with reference to FIG. 11.

In each one of the first to third embodiments, the tactile switches 27, each of which detects pressing of the corresponding push button 11a to 14a, and the associated control circuit 28, which controls light emission of the light emitting elements 23 in correspondence with a detection result of the tactile switches 27, are mounted on the main substrate 24 fixed to the vehicle body. In contrast, in the fourth embodiment, such tactile switches and control circuit are mounted on a substrate fixed to the corresponding push button 11a to 14a. In this manner, the entire portion of the configuration related to display of information regarding the operation setting of the corresponding on-vehicle apparatus, which is switched through pressing of each push button 11a to 14a, is integrated in the push button 11a to 14a.

FIG. 11 shows a cross section showing a switch with information display according to the fourth embodiment. Although only the compartment temperature adjustment switch 12 is illustrated in the drawing, the other switches 11, 13, 14 are configured basically identical with the switch 12.

Also in the fourth embodiment, a substrate 50 on which the light emitting elements 23 are mounted is fixed to the backside of the push button 12a of the switch 12. However, in the fourth embodiment, tactile switches 51 each detecting pressing of the push button 12a and a control circuit 52 controlling light emission of the light emitting elements 23 in correspondence with a detection result of the tactile switch 51 are mounted on the backside of the substrate 50. Each one of the tactile switches 51 is held in contact with the distal end of the corresponding one of projections 53 fixed to the vehicle body. Specifically, in each one of the compartment temperature adjustment switch 12, the air flow amount adjustment switch 13, and the seat temperature adjustment switch 14, a pair of tactile switches 51 and a pair of projections 53 are provided at opposite ends of the corresponding one of the push buttons 12a to 14a. In contrast, the vent mode switch 11 includes only a single tactile switch 51 and a single projection 53.

The fourth embodiment of the present invention, which has been described so far, has the following advantage in addition to the above-described advantages of the first to third embodiments.

In addition to the light emitting elements 23, the tactile switches 51 and the control circuit 52 are also mounted on the substrate 50 fixed to each one of the push buttons 11a to 14a. That is, the entire portion of the configuration related to display of information regarding the operation setting of the corresponding on-vehicle apparatus, which is switched through pressing of the push button 11a to 14a, is integrated in the push button 11a to 14a. This further saves space for installing the switches 11 to 14. Also, since the switches 11 to 14 with information display function are provided as an integral assembly, the switches 11 to 14 are easily handled.

The illustrated embodiments may be embodied in the following modifications.

The configuration related to the surface treatment of each push button 11a to 14a is not restricted to those illustrated in FIGS. 5, 7, and 9 but may be modified as needed. For example, if each adjacent pair of the segments are spaced from each other by a sufficient distance and light leakage to non-illuminated segments does not occur, the paint layer 32, 43 may be formed on the top surface of the base material 30, 40.

The switch with information display function for the on-vehicle apparatus according to the present invention is embodied as a switch operated to successively switch the operation setting of either the car air conditioner or the seat temperature adjustment apparatus. However, the switch may be embodied as a switch operated to switch the operation setting of other types of on-vehicle apparatuses such as an audio device or a navigation device. That is, the present invention may be used in a switch by which the volume of the audio device or the reception frequency of a radio is switched from one level to another. Specifically, the volume of the audio device is illuminated and displayed numerically or in correspondence with the length of a bar on the surface of the corresponding push button. The reception frequency of the radio is illuminated and numerically displayed on the surface of the corresponding push button. In other words, as long as the switch with information display function for an on-vehicle apparatus according to the present invention is embodied as a push button switch operated to sequentially switch the operation setting of the on-vehicle apparatus in more than two steps through pressing of a push button, the switch may be any suitable switch by which any type of operation setting of any suitable on-vehicle apparatus is switched.

Therefore, the present examples and embodiments are to be considered as illustrative and not restrictive and the invention is not to be limited to the details given herein, but may be modified within the scope and equivalence of the appended claims.

What is claimed is:

1. A switch having an information display function for an on-vehicle apparatus, comprising:
a push button, wherein an operation setting of the on-vehicle apparatus is successively changed in more than two steps by pushing operation of the push button; and
an information display portion having a plurality of light emitting elements, the information display portion arranged integrally with the push button,
wherein a specific symbol is displayed on the push button in accordance with each step of the operation setting of the on-vehicle apparatus, the symbol being expressed by a combination of segments that are selectively illuminated when the light emitting elements are turned on.

2. The switch according to claim 1, wherein the operation setting of the on-vehicle apparatus is successively changed in response to the pushing operation of the push button, and the information display portion numerically displays the current operation setting of the on-vehicle apparatus.

3. The switch according to claim 2, wherein the on-vehicle apparatus includes an air-conditioner, a target temperature of the air-conditioner is successively changed in response to the pushing operation of the push button, and the information display portion numerically displays the target temperature by light emission.

4. The switch according to claim 1, wherein the operation setting of the on-vehicle apparatus is successively changed in response to the pushing operation of the push button, and the information display portion displays a bar having a length that corresponds to the value of the current operation setting of the on-vehicle apparatus by light emission.

5. The switch according to claim 1, wherein the push button is made of material having light transmittance, and has opposite front and back surfaces, the front surface is pushed by an operator, and
wherein the information display portion includes a substrate on which the light emitting elements are located, the substrate being located behind the back surface of the push button.

6. The switch according to claim 5, further comprising:
a tactile switch which detects the push operation of the push button; and
a control circuit that controls the light emission of the light emitting elements in response to the detection of the push operation of the push button, wherein the tactile switch and the control circuit are arranged on the substrate.

7. The switch according to claim 5, wherein a paint layer is formed on the back surface of the push button, the paint layer is made of paint having light shielding function, and portions of the paint layer that correspond to the segments are removed.

8. The switch according to claim 6, wherein a paint layer is formed on the back surface of the push button, the paint layer is made of paint having light shielding function, and portions of the paint layer that correspond to the segments are removed.
